(19) United States
(12) Patent Application Publication
(10) Pub. No.: US 2006/0080992 A1
(43) Pub. Date: Apr. 20, 2006

(54) Refrigerating device for a water station

(75) Inventor: Qizhan Zhou, Hangzhou (CN)

Correspondence Address: DENNISON, SCHULTZ, DOUGHERTY & MACDONALD, 1727 KING STREET, SUITE 105, ALEXANDRIA, VA, 22314, US

(73) Assignee: Qidi Electric Group Co., Ltd.

(21) Appl. No.: 11/024,664

(22) Filed: Dec. 30, 2004

(30) Foreign Application Priority Data
Oct. 19, 2004 (CN) 200410067280.4

(51) Int. Cl. B67D 5/62; F25D 17/06

(52) U.S. Cl. 62/389

(57) ABSTRACT

A refrigerating device for a water station comprises cold storage cabinet, cold water container and refrigerating system. Said cold water container is installed in the cold storage cabinet, one end of which is connected to a water storage pail via a pipeline, and the other end is provided with a water intake pipeline. The cold water container is used for holding water that needs temperature drop. Said refrigerating system comprises compressor, condensator, capillary tubes, first evaporator and refrigerating pipelines. Said first evaporator can be installed in the cold storage cabinet or can also be installed outside the cold storage cabinet in coordination with it. Said compressor is installed under the cold storage cabinet, said refrigerating pipelines are filled with refrigerating liquid. The refrigerating device for water station of the present invention has the following advantages: the structure being simple and rational, the speed of refrigeration quick, the heat stability excellent and the utilization ratio of cold capacity high.

### TECHNICAL FIELD

The present invention relates to a refrigerating device for a water station, in particular to a refrigerating device for water station with a cold storage cabinet refrigerated through a compressor.

### DESCRIPTION OF THE PRIOR ART

At present, the components of a conventional cold and hot water station with a cold storage cabinet refrigerated by a compressor chiefly comprise compressor, cold water container, cold storage cabinet and condensator. The refrigerating device of such kind of water station is that the cold water container and the cold storage cabinet are installed in a same refrigerating system and the cold water container and the cold storage cabinet are installed separately. They both have one independent evaporator, one for the cold water container, and the other for the cold storage cabinet. These Two evaporators are used to conduct heat exchange for the refrigerated substances, so as to evaporate the heat and to achieve the aim of refrigeration.

However, this refrigerating device of the water station has the following shortcomings:

1. The ability of the refrigerating device to counteract the interference of temperature fluctuation is poor, that is, the heat stability is poor.

2. The utilization ratio of the cold capacity of the refrigerated substances does not reach the maximum.

### SUMMARY OF THE INVENTION

The object of the present invention is to provide a refrigerating device for a water station, the structure of which is simple and rational, the speed of refrigeration is quick, the heat stability is excellent, and the utilization ratio of cold capacity is high.

In order to achieve the above-mentioned object, the present invention provides a refrigerating device for a water station, which comprises cold storage cabinet, cold water container and refrigerating system. Said cold water container is installed within the cold storage cabinet, one end of the container is connected to a water storage pail via a pipeline, and the other end is provided with a water intake pipeline. The cold water container is used for holding water that needs temperature drop.

Said refrigerating system comprises compressor, condensator, capillary tubes, first evaporator and refrigerating pipelines. Said first evaporator can be installed in the cold storage cabinet or can also be installed outside the cold storage cabinet in coordination with the cold storage cabinet. Said compressor is installed under the cold storage cabinet said refrigerating pipelines are pilled with refrigerating liquid.

When the compressor is started, the refrigerating liquid repeatedly makes heat exchanging cyclic motions, such as “vaporization-liquidization-vaporization—“, that is, the first evaporator is to vaporize the low pressure refrigerating liquid taking the temperature at that time as room temperature, so to absorb a large amount of heat from the pipe wall and the surroundings, for example, the heat within the cold storage cabinet. An incessant cycling in this way makes the temperature in the cold storage cabinet continually lowered down, thereby the temperature of the refrigerated substance, i.e., the water placed in the cold water container and the air in the surrounding atmosphere is also continually lowered down along with it, so to achieve the aim of refrigeration.

The present invention provides a refrigerating device for a water station in which a mated second evaporator can also be installed outside the cold water container. This second evaporator together with the first evaporator mated with the cold storage cabinet conduct the refrigeration process through heat exchange.

The present invention provides a refrigerating device for a water station in which the cold storage cabinet can be partitioned in accordance with different requirements, so that two modes of refrigerating operations, namely quick cooling and cold storage, can be adopted.

The refrigerating device of a water station provided by the present invention has the following advantages:

1. As the cold water container is installed within the cold storage cabinet, that makes a chilling unit which is added to the cold storage cabinet, so that the speed of refrigeration in the cold storage cabinet can be greatly quickened.
Meanwhile, as the cold water container is installed within the cold storage cabinet, the cold water container is in a circumstance of comparatively lower temperature, so that the time for refrigerating the water in the cold water container is much shorter than that if the cold water container is installed outside of the cold storage cabinet, that is, the cold storage cabinet and the cold water container influence with and react on each other so to speed up the refrigeration.

2. As a chilling unit, like the cold water container, is installed within the cold storage cabinet so that the ability of the cold storage cabinet to counteract the interference of temperature fluctuation is greatly strengthened and it is easier for the cold storage cabinet to maintain the set temperature.

3. As the cold water container is installed within the cold storage cabinet, the overall refrigerating device of the water station can be designed more superiorly. That means, a larger evaporator for the cold storage cabinet can be installed in accordance with requirement, or it is also possible for the cold storage cabinet and the cold water container to have their own evaporator respectively. In this way, the counter-interference ability of the refrigerating system is comparatively stronger and the stability of temperature is better.

4. As the cold water container is installed within the cold storage cabinet, as for the layout of structure, the cold water container is remote from the hot liner of the water station; the refrigerating system and the heating system do not interfere with each other. The layout is rational; it strengthens the stability of temperature of the cold water in the cold water container and hot water in the hot liner. At the same time, it also saves energy.

### BRIEF DESCRIPTION OF THE DRAWINGS

FIG. 1 is a schematic view of the structure of a refrigerating device for a water station provided by the present invention.

### DETAILED DESCRIPTION OF THE INVENTION

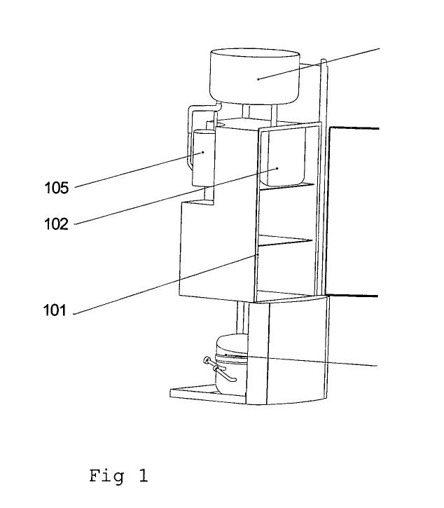

The following is the description of a preferred embodiment of the present invention with reference to FIG. 1.

As shown in FIG. 1, it is a schematic view of the structure of the refrigerating device for a water station provided by the present invention, which comprises cold storage cabinet 101, cold water container 102 and refrigerating system. Said cold water container 102 is installed within the cold storage cabinet 101, one end of which is connected to a water storage pail 103 via a pipeline and the other end is provided with a water intake pipeline (not shown in the drawing) for intake of water. The water container 102 is used for holding water that needs to be refrigerated.

Said refrigerating system comprises compressor 104, condensator (not shown in the drawing), capillary tubes (not shown is the drawing), first evaporator (not shown in the drawing) and refrigerating pipelines (not shown in the drawing). Said first evaporator can be installed within the cold storage cabinet 101, or can also be installed, outside the cold storage cabinet 101 in coordination with the cold storage cabinet 101. Said compressor 104 is installed under the cold storage cabinet 101, said refrigerating pipelines are filled with refrigerating liquid.

When the compressor 104 is started, the refrigerating liquid repeatedly makes heat exchanging cyclic motions, such as “vaporization-liquidization-vaporization—“that is, the first evaporator is to vaporize the low pressure refrigerating liquid taking the temperature at that time as room temperature, so to absorb a large amount of heat from the pipewall and the surroundings, for example, the heat within the cold storage cabinet 101. An incessant cycling in this way makes the temperature in the cold storage cabinet 101 continually lowered down, thereby the temperature of the refrigerated substance, i.e., the water placed in the cold water container 102 and the air in the surrounding atmosphere is also continually lowered down along with it, so to achieve the aim of refrigeration.

The present invention provides a refrigerating device for a water station in which a mated second evaporator can also be installed outside the cold water container 102. This second evaporator together with the first evaporator mated with the cold storage cabinet 101 conduct the refrigeration process through heat exchange.

The present invention provides a refrigerating device for a water station in which the cold storage cabinet 101 can be partitioned in accordance with different requirements, so that in the cold storage cabinet 101 can be installed respectively a quick-cooling chamber and a cold storage chamber.

The refrigerating device of water station provided by the present invention has the following advantages:

1. As the cold water container 102 is installed within the cold storage cabinet 101 and as the refrigerating system refrigerates the cold water container 102 and, the cold storage cabinet 101 simultaneously, that makes a chilling unit which is added to the cold storage cabinet 101 so that the speed of refrigeration in the cold storage cabinet 101 is greatly quickened.
Meanwhile, as the cold water container 102 is installed within the cold storage cabinet 101, the cold water container 102 is in a circumstance of comparatively lower temperature, so that the time for refrigerating the water in the cold water container 102 is much shorter than that if the cold water container 102 alone is installed outside of the cold storage cabinet, that is, the cold storage cabinet 101 and the cold water container 102 influence with and react on each other so to speed up the speed of refrigeration.

2. As the cold storage cabinet 101 is installed within a cold water container 102, as described above, the cold storage cabinet 101 and the cold water container 102 influence with and react on each other, so that the ability of the cold storage cabinet 101 to counteract the interference of temperature fluctuation is greatly strengthened and it is easier for the cold storage cabinet 101 to maintain the set temperature.

3. As the cold water container 102 is installed within the cold storage cabinet 101, the overall refrigerating device of the water station can be designed more superiorly, that means, a larger evaporator for the cold storage cabinet 101 can be installed in accordance with requirement, or it is also possible for the cold storage cabinet 101 and the cold water container 102 to have their own evaporator respectively. On this way, the counter-interference ability of the refrigerating system is comparatively stronger and the stability of temperature is better.

4. As the cold water container 102 is installed within the cold storage cabinet 10, as for the layout of structure, the cold water container 102 is remote from the hot liner 105 of the water station, the refrigerating system and the heating system do not interfere with each other. The layout is rational, it strengthens the stability of temperature of the cold water in the cold water container 102 and hot water and in the hot liner 105. At the same time, it also saves energy.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A refrigerating device for a water station, comprising cold storage cabinet (101), cold water container (102) and refrigerating system, characterized in that,
Said cold water container (102) is installed within the cold storage cabinet (101);
The refrigerating system refrigerates the cold water container (102) and the cold storage cabinet (101) simultaneously, that makes a chilling unit which is added to the cold storage cabinet (101), so that the speed of refrigeration in the cold storage cabinet (101) can be greatly quickened;
The cold water container (102) is in a circumstance of comparatively lower temperature, so that the time for refrigerating the substance in the cold water container (102) is much shorter than that if the cold water container (102) alone is installed outside of the cold storage cabinet, that is, the cold storage cabinet (101) and the cold water container (102) influence with and react on each other so to speed up the speed of refrigeration, and also the ability of the cold storage cabinet (101) to counteract the influence of temperature fluctuation is greatly strengthened and it is easier for the cold storage cabinet (101) to maintain the set temperature;
One end of said cold water container (102) is connected to a water storage pail (103) via a pipeline and the other end is provided with a water intake pipeline;
Said refrigerating system comprises compressor (104), condensator, capillary tubes, first evaporator and refrigerating pipelines;
Said first evaporator can be installed in the cold storage cabinet (101), in coordination with the cold storage cabinet (101):

2. The refrigerating device for a water station as claimed in claim 1, characterized in that said compressor (104) is installed under the cold storage cabinet (101).

3. The refrigerating device for a water station as claimed in claim 2, characterized in that a mated second evaporator can also be installed outside the cold water container (102).

4. The refrigerating device for a water station as claimed in claim 3, characterized in that in the cold storage cabinet (101) are installed respectively a cold storage chamber and a quick-cooling chamber.

5. The refrigerating device for a water station as claimed in claim 3, characterized in that the water station has a hot liner (105), the cold water container (102) is remote from the hot liner (105) of the water station;
The refrigerating system and the heating system do not interfere with each other, it strengthens the stability of temperature of the cold and hot water in the cold water container (102) and in the hot liner (105), and saves energy at the same time.

6. The refrigerating device for a water station as claimed in claim 3, characterized in that said refrigerating pipelines are filled with refrigerating liquid.

7. A refrigerating device for a water station, comprising cold storage cabinet (101), cold water container (102) and refrigerating system, characterized in that,
Said cold water container (102) is installed within the cold storage cabinet (101);
The refrigerating system refrigerates the cold water container (102) and the cold storage cabinet (101) simultaneously, that makes a chilling unit which is added to the cold storage cabinet (101), so that the speed of refrigeration in the cold storage cabinet (101) can be greatly quickened;
The cold water container (102) is in a circumstance of comparatively lower temperature, so that the time for refrigerating the substance in the cold water container (102) is much shorter than that if the cold water container (102) alone is installed outside of the cold storage cabinet, that is, the cold storage cabinet (101) and the cold water container (102) influence with and react on each other so to speed up the speed of refrigeration, and also the ability of the cold storage cabinet (101) to counteract the influence of temperature fluctuation is greatly strengthened and it is easier for the cold storage cabinet (101) to maintain the set temperature;
One end of said cold water container (102) is connected to a water storage pail (103) via a pipeline and the other end is provided with a water intake pipeline;
Said refrigerating system comprises compressor (104), condensator, capillary tubes, first evaporator and refrigerating pipelines;
Said first evaporator can be installed outside the cold storage cabinet (101); in coordination with the cold storage cabinet (101).

8. The refrigerating device for a water station as claimed in claim 1, characterized in that said compressor (104) is installed under the cold storage cabinet (101).

9. The refrigerating device for a water station as claimed in claim 2, characterized in that a mated second evaporator can also be installed outside the cold water container (102).

10. The refrigerating device for a water station as claimed in claim 3, characterized in that in the cold storage cabinet (101) are installed respectively a cold storage chamber and a quick-cooling chamber.

11. The refrigerating device for a water station as claimed in claim 3, characterized in that the water station has a hot liner (105), the cold water container (102) is remote from the hot liner (105) of the water station,
the refrigerating system and the heating system do not interfere with each other, it strengthens the stability of temperature of the cold and hot water in the cold water container (102) and in the hot liner (105), and saves energy at the same time.

12. The refrigerating device for a water station as claimed in claim 3, characterized in that said refrigerating pipelines are filled with refrigerating liquid.
